(19) United States
(12) Patent Application Publication
(10) Pub. No.: US 2013/0013459 A1
(43) Pub. Date: Jan. 10, 2013

(54) DYNAMIC PRICING OF ONLINE CONTENT

(75) Inventors: Monty L. Kerr, San Francisco, CA (US); Alexander K. St. John, San Francisco, CA (US); Rajat Kongovi, San Francisco, CA (US)

(73) Assignee: hi5 Networks, Inc., San Francisco, CA (US)

(21) Appl. No.: 13/178,237

(22) Filed: Jul. 7, 2011

(51) Int. Cl. G06Q 30/00

(52) U.S. Cl. 705/27.1; 705/400

(57) ABSTRACT

In various embodiments, the present disclosure provides a method, apparatus, and system for dynamically pricing online content. The method may include determining a geographic location of a user consuming or interested in consuming an online content hosted by the service provider. At least one price point may be determined at which to offer to the user rights to consume the online content or virtual goods associated with the online content. The price point may be tailored for the geographic location to increase likelihood of acceptance of the offer by the user. The price point may be presented to the user. Other embodiments may be disclosed and/or claimed.

### TECHNICAL FIELD

Embodiments of the present disclosure relate generally to the technical field of data processing, and more specifically to monetizing network content, including dynamic pricing of online content provided by a service provider.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Service providers may provide or facilitate content for consumption by users over a computer network. Content of a service provider may be consumed in various ways, and may include all or a portion of a network application provided by the service provider. For example, a user may consume content when the user plays all or a portion of a network computer game, or utilizes some aspect or resource of the network computer game.

A user may be required to meet various requirements prior to consuming content. For example, in a network computer game relating to real estate development, content may take the form of virtual real estate, and one way a user may consume content is to purchase virtual real estate. However, in order to purchase the real estate, the user may be required to use some amount of virtual currency.

Virtual currency can be obtained by a user in various ways. When a user initially purchases the rights to consume content such as a network computer game, the user may be provided with a default amount of virtual currency. The user may subsequently achieve various goals or objectives, such as in a network computer game. The user may also obtain additional currency by purchasing more virtual currency, using real currency.

### SUMMARY

In various embodiments, the present disclosure provides a method for dynamically pricing online content. The method may include determining a geographic location of a user consuming or interested in consuming an online content hosted by the service provider, determining at least one price point at which to offer to the user rights to consume the online content or virtual goods associated with the online content, and presenting the price point to the user. In various embodiments, the price point may be tailored for the geographic location to increase likelihood of acceptance of the offer by the user.

### BRIEF DESCRIPTION OF THE DRAWINGS

In the following detailed description, reference is made to the accompanying drawings which form a part hereof wherein like numerals designate like parts throughout, and in which is shown by way of embodiments that illustrate principles of the present disclosure. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

FIG. 1 schematically illustrates a system according to an embodiment of the disclosure.

FIG. 2 schematically depicts a monetization module according to an embodiment of the disclosure.

FIG. 3 depicts a method of dynamically pricing online content, in accordance with an embodiment of the disclosure.

FIG. 4 depicts an example interface for presenting price points to a user, in accordance with an embodiment of the disclosure.

FIG. 5 depicts another example interface for presenting price points to a user, in accordance with an embodiment of the disclosure.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrases “A/B” and “A and/or B” mean (A), (B), or (A and B); and the phrase “A, B, and/or C” means (A), (B), (C), (A and B), (A and C), (B and C) or (A, B and C).

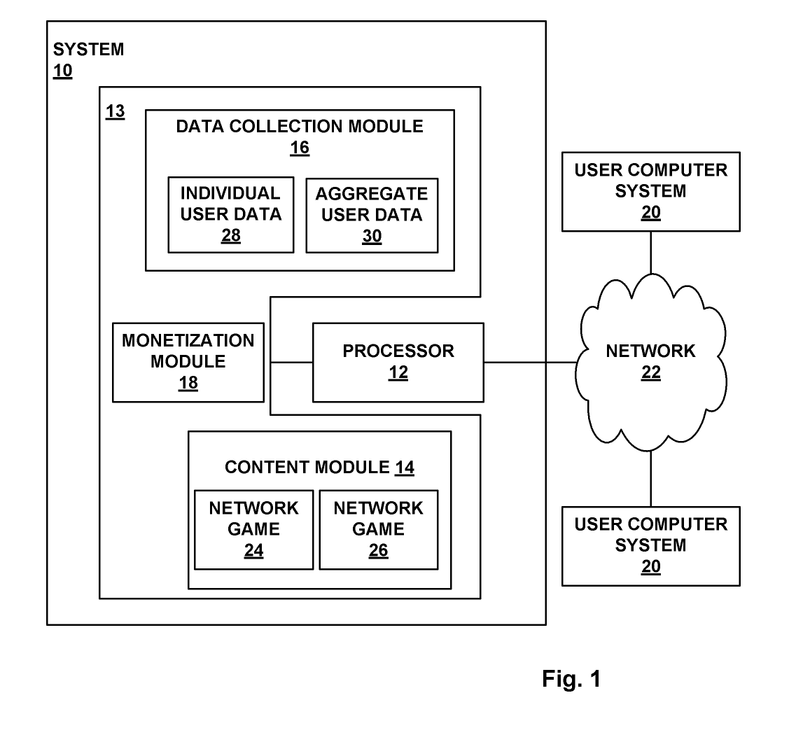

Referring now to FIG. 1, an example computer system 10 includes one or more processors 12 operably coupled to memory 13. While not shown, computer system 10 may include other standard components, such as memory, input and output devices, buses, network interfaces, and so forth. Additionally or alternatively, computer system 10 may include server computers, connected for example by a computer network.

Computer system 10 may include in memory 13 a content module 14, a data collection module 16 and a monetization module 18, each being operable by the one or more processors 12 to perform various functions described below. Although memory 13 is depicted in FIG. 1 as being a single memory, this is not meant to be limiting, and the various modules may be distributed among memories of multiple computers and/or computer systems. For example, each of content module 14, data collection module 16 and monetization module 18 may be included in a separate memory of a separate computer, and those separate computers may be in network communication with each other.

Computer system 10 may be in network communication with one or more user computer systems 20 via a computer network 22. Computer network 22 may be one or more local area networks (“LAN”) and/or one or more wide area networks (“WAN”), including the Internet.

Content module 14 may be operated by processor 12 to provide content offered by a service provider for consumption by one or more users at one or more user computer systems 20 over computer network 22. The content offered by a service provider may or may not be created and/or owned by the service provider. The content offered by a service provider may include one or more network computer games, such as first network game 24 and second network game 26 shown in FIG. 1, as well as content within a network computer game, such as a piece of virtual real estate or virtual food. In some embodiments, network computer games may be related to and/or facilitated as part of a social network.

Data collection module 16 may be operated by processor 12 to collect data relating to consumption, by users, of content provided by the service provider, e.g., using content module 14. This data may be collected over a period of time, such as from the launch of a network computer game onwards. The data collected may include individual user data 28 relating to consumption of content by individual users. Additionally, the collected data may include aggregate user data 30 relating to consumption by a plurality of users. As will be discussed below, data collected by data collection module 16 may be used by other components, such as content module 14 and/or monetization module 18, for various purposes.

Users that are consuming or interested in consuming online content may be more likely to purchase the online content at particular price points. Reasons for this may vary, and may include various factors, such as the user's geographic location, demographics, spending history, time of day and so forth. Accordingly, monetization module 18 may be operated by processor 12 to determine at least one price point at which to offer to a user rights to consume online content or virtual goods (e.g., virtual currency, virtual real estate, virtual resources) associated with the online content of a service provider. The price point(s) may be based on various information to increase a likelihood of acceptance of the offer by the user.

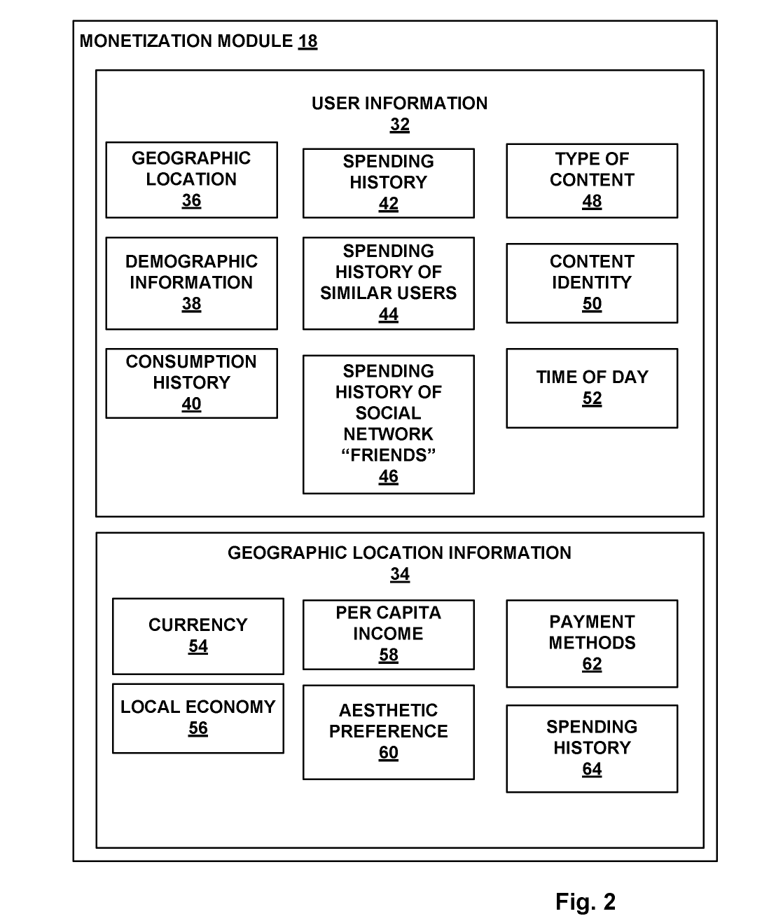

Referring to FIG. 2, monetization module 18 may have access to various information, such as user information 32 and geographic location information 34, from which to determine price points. User information 32 and/or geographic location information 34 may be stored in various forms, such as in records of a database on one or more computer systems, or in a data file on one or more computer systems. User information 32 and/or geographic location information 34 may be made available by various components, such as data collection module 16, to other components, such as monetization module 18. In some embodiments, user information 32 may be stored with individual user data 28.

User information 32 may include a geographic location 36 of the user. A “geographic location,” as used herein, may include but is not limited to a user's global positioning system (“GPS”) coordinates, address, neighborhood, city, county, state, province, country, and so forth. Monetization module 18 and/or content module 14 may utilize an Internet Protocol (“IP”) address of the user to determine a user's geographic location. Additionally or alternatively, content module 14 and/or data collection module 16 may solicit a geographic location from a user at various points, such as when the user initially signs up to consume online content provided by a service provider. In embodiments where the geographic location 36 is a GPS coordinate or an address, the term “region” may be used herein to describe an area proximate to the geographic location 36, such as a neighborhood, county, city, state, province, and so forth.

User information 32 also may include other information about the user, such as demographic information 38. Demographic information 38 of a user may include but is not limited to the user's gender, age, race, religion, nationality, weight, height, marital status, and so forth.

User information 32 also may include a user's consumption history 40 of online content. Consumption history 40 may include a history of a user's consuming online content hosted by a particular service provider, or of the user consuming a particular content. Consumption history 40 also may include types of content the user tends to consume. For example, one user may tend to consume mostly fantasy role-playing network computer games, whereas another user may tend to consume mostly real estate network computer games. Consumption history 40 additionally may identify specific content consumed by a user, such as the name(s) of network computer games played by a user. Consumption history 40 may include other information about a user's consumption of online content as well, such as how long the user typically consumes content, how often, how recently, and so forth.

User information 32 also may include spending history 42 of a user. Spending history 42 may include a user's history of purchasing rights to consume online content or virtual goods associated with online content. This information may include, but is not limited to, how frequently a user spends money for rights to consume online content or virtual goods associated with online content, how much the user is willing to pay for such rights, or how recently the user purchased content. Spending history 42, alone or in combination with consumption history 40, may be used to estimate the user's level of “addiction” to a particular online content, so that price points for the content can be determined accordingly.

User information 32 also may include information about multiple users, such as aggregate user data 30 of data collection module 16. In some embodiments, spending history of users who are similar to the user (e.g., demographically) may be used to determine price points. For example, to determine a price point at which to offer rights to consume online content to a 34-year-old male, monetization module 18 may utilize spending history of similar users 44, e.g., spending history of males between 33 and 37.

User information 32 also may include spending history of social network “friends” or “buddies.” For example, some of a user's “friends” in a given social network may also be users who consume content provided by a service provider. Monetization module 18 may analyze these friends' spending history 46 in order to determine a price point that likely will be accepted by the user.

User information 32 also may include information about content the user is consuming or wishes to consume. For example, online content hosted by the service provider may have a plurality of “types.” A price point of online content the user is consuming or is interested in consuming may be determined based on a particular type of the online content 48. Additionally or alternatively, a price point may be determined based in part on spending history of other users of the type of online content the user is consuming or is interested in consuming.

A “type” of online content may include but is not limited to a genre of the online content, a creator of the online content (e.g., an author), or a contributor to the online content (e.g., a musician who supplied a song or an actor who contributed voice-over to a network computer game).

In addition to the type of content the user is consuming or wishes to consume, the identity of the content 50 may also be used to determine price points. For example, online content hosted by a particular service provider may include a plurality of network computer games. A price point may be determined based on which network computer game of the plurality of network computer games is being played by a user.

User information 32 also may include a time of day 52 of the user. Users in the aggregate (as determined, for example, from aggregate user data 30) may be more likely to spend more money (i.e., accept higher price points) after dinner than at lunchtime. Thus, if a user consumes or is interested in consuming an online content of a service provider at lunchtime, one or more price points may be determined that are lower than those that may be determined after dinner.

In addition to or instead of user information 32, one or more price points at which to offer a user rights to consume online content or associated virtual goods may be tailored for the geographic location of the user, to increase likelihood of acceptance of the offer by the user. Thus, monetization module 18 may have access to geographic location information 34 or a variety of locations or regions. Once a user's geographic location 36 is determined, it may be cross-referenced to corresponding geographic location information 34.

Geographic location information 34 may include a type of currency 54 used at the geographic location. As will be described below, online content (or associated virtual goods) may be offered to the user in his or her local currency. Currency exchange rates for a user's local currency versus other currencies, such as that of a service provider, also may be analyzed and used to determine price points.

Geographic location information 34 also may include information about the local economy 56 and/or a per capita income 58 of people at or near the user's geographic location 36. If a local economy is bad and/or per capita income is low, then monetization module 18 may determine that the user may not be likely to accept offers at higher price points. Conversely, if a local economy is good and/or per capita income is high, then monetization module 18 may determine that the user is more likely to accept an offer at a higher price point.

Geographic location information 34 also may include an aesthetic preference 60 of users at or near the geographic location. For example, users at or near one geographic location may be more likely to accept offers at price points that end with “0.00” or “0.99,” and less likely to accept offers at price points that end in “0.37,” or “0.66.” As another example, users at or near one geographic location may be more likely to accept offers when presented with a relatively large number of price points (e.g., seven), whereas users at or near another geographic location may be more likely to accept offers when presented with a relatively small number of price points (e.g., one or two). Aesthetic preference 60 may be determined heuristically from users in a region in various ways. In some embodiments, monetization module 18 may analyze data about spending history of a particular region's users, collected, for instance, by data collection module 16, and draw conclusions about what price points are preferred, aesthetically, by the users of the region.

Geographic location information 34 also may include one or more payment methods 62 available at or near a geographic location. In most areas it may be possible to pay with cash or credit card. But in some areas, other payment methods are available. For example, users in some areas accumulate so-called “mobile points” on cellular telephones. The users may use these mobile points, in lieu of cash, to purchase rights to online content or associated virtual goods. Other payment methods include, but are not limited to credit card points, credit card miles, tokens, and so forth.

Geographic location information 34 also may include spending history 64 of users at or near the geographic location. Monetization module 18 may predict what a user might be willing to spend for rights to consume online content, based on what nearby users are willing to spend. For example, a city-dweller may be more likely to spend a higher amount of money than a user in a rural setting.

With user information 32 and/or geographic location information 34, monetization module 18 may determine one or more price points at which to offer a user rights to consume content or associated virtual goods. Then, monetization module 18 may cause the price point to be presented to the user, e.g., at a user computer system 20 of the user. In some embodiments, monetization module 18 may transmit the price point(s) directly to the user at user computer system 20 over computer network 22. In other embodiments, monetization module 18 may provide the price point to content module 14, which in turn may transmit the price point(s) to the user at user computer system 20.

Price points may be determined using other information besides user information 32 or geographic information 34. For example, in some embodiments a price point and/or an amount of virtual goods may be determined based at least in part on the risk that a user will not complete a transaction. For instance, a minor may run up a parent's credit card bill purchasing a large amount of a virtual good without the parent's knowledge. Such a parent may be likely to refuse to pay the bill and/or claim it as fraud. This may be avoided by limiting a price point (or an accumulation of price points) so that a parent is more likely to pay the resulting credit card bill than claim fraud. As another example, a price point and/or amount of virtual good may be based on a value expected to be received by a content provider.

In some embodiments, multiple price points may be determined based on geographic location information 34 and/or user information 32. The user may then be presented with a number of price points of the plurality of price points from which to select. The number of price points presented to the user may be determined heuristically, e.g., by monetization module 18, from one or more of past activity of the user (e.g., consumption history 40 and/or spending history 42) or past activity of a plurality of users at or near a geographic location (e.g., spending history 64). The number of price points offered may be based on a number of factors, including but not limited to a number of viable payment methods in a particular area, optimal price points of those payment methods, and analytic insight into a price point matrix that produces optimal purchasing yields.

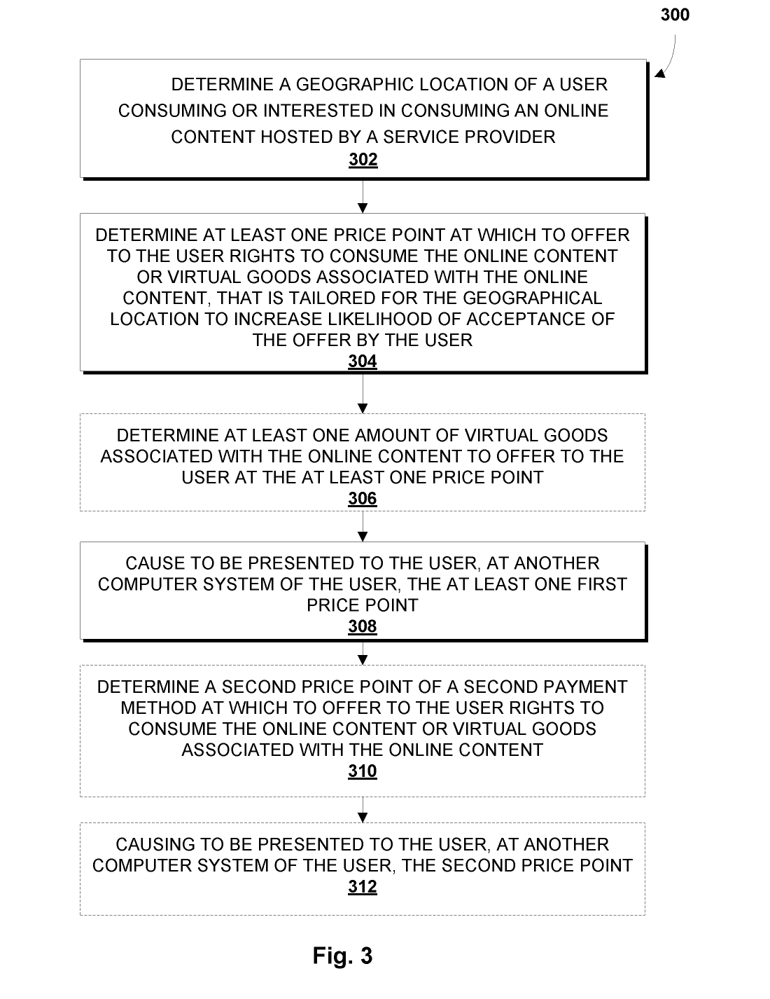

An example method 300 for dynamically pricing online content is depicted in FIG. 3. Although shown in a particular sequence, this is not meant to be limiting and one or more actions may be performed in orders not shown without departing from the spirit of the disclosure. For example, some of the actions in FIG. 3 are in dashed lines, indicating that they may be optional in some embodiments.

At 302, content module 14 and/or monetization module 18 may determine a geographic location 36 of a user consuming or interested in consuming an online content hosted by a service provider.

At 304, monetization module may determine at least one price point at which to offer to the user rights to consume online content or virtual goods associated with the online content. The price point may be tailored, e.g., by monetization module 18, for the geographic location determined at 302, to increase likelihood of acceptance of the offer by the user. For example, monetization module 18 may determine the price point based in part on one or more payment methods (e.g., credit card, mobile points, cash, tokens) that are likely to be used at or near the geographic location of the user.

In some embodiments, such as that shown in FIG. 3, a user may consume or be interested in consuming a virtual good that is capable of being quantified. In such embodiments, at 306, at least one amount of virtual goods may be determined to offer to the user at the price point(s) determined at 304. For example, it may be determined, e.g., by monetization module 18, that a user is likely to accept an offer at a price point of $1 for 100 units of a particular virtual good. In some embodiments, the amount may be calculated based on information provided by a service provider of online content being consumed or of a developer of the online content.

Regardless of whether the online content or associated goods are quantified at 306, at 308, the determined price point(s) may be presented, e.g., by monetization module 18 or content module 14, to the user at user computer system 20.

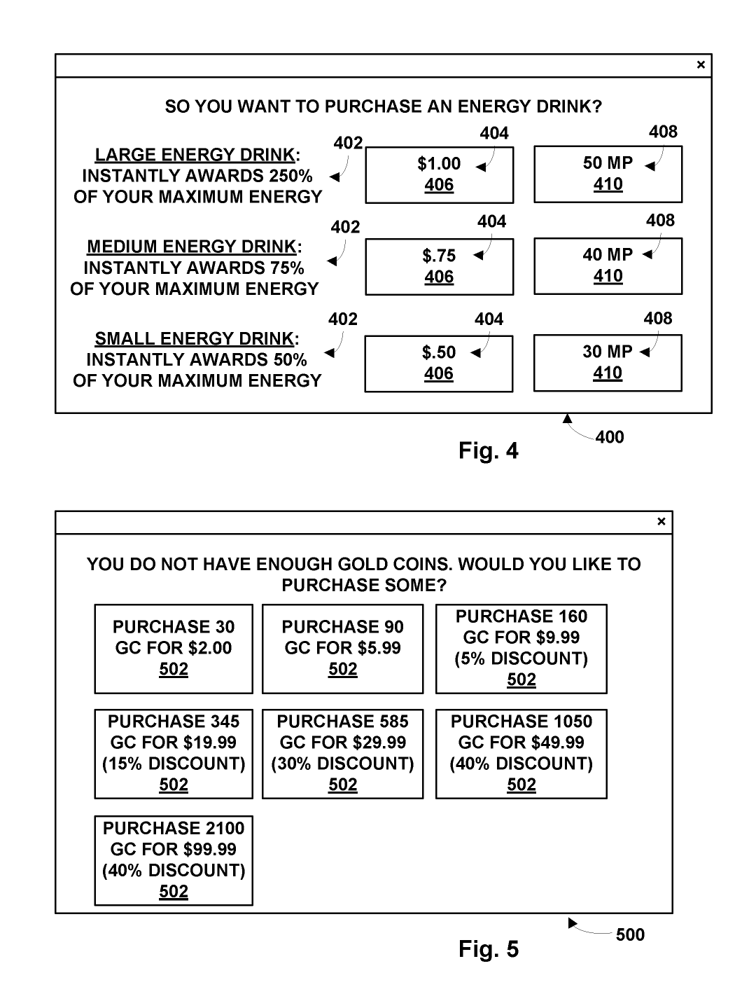

An example of this is seen in FIG. 4, which depicts a screenshot of a user interface 400 associated with content in the form of a network computer game. In FIG. 4 the user is presented (308) three amounts 402 of virtual goods, in the form of three different sizes of “energy drinks” that are game elements of the network computer game. The three different amounts 402 of goods are being offered to the user at three respective price points 404 of a first payment method (U.S. cash). The three price points of the first payment method in this example are positioned on three buttons 406, so that the user may select the most appealing price point/amount combination.

As noted above, in some embodiments, multiple payment methods may be used by users, and price points may be determined and presented in each payment method. Referring back to FIG. 3, at 310, a second price point of a second payment method at which to offer to the user rights to consume the online content or associated virtual goods may be determined. At 312, the second price point may be presented to the user at user computer system 20. An example of this is seen in FIG. 4. Three additional price points 408 are presented (312) to a user via in a second payment method (mobile points, or “MP”) via three additional buttons 410.

Content module 14 and/or monetization module 18 may determine, from user information 32 and/or geographic location information 34, that a user is not likely to accept an amount(s) of virtual goods at a presented price point(s). In such cases, monetization module 18 may be operated by processor 12 to determine a discount price point at which to offer the at least one amount of virtual goods to the user. The discount price point may stand a better chance of being accepted by the user than a price point that would have been determined otherwise. In some embodiments, monetization module 18 may engage in volume discounting. For example, monetization module 18 may offer a high volume of quantifiable content, such as virtual currency, to a user for sale at a low per-unit price point. This may increase a user's interest in the content because the user may feel she is getting a bargain for purchasing in bulk.

After a user accepts or rejects one or more price points (e.g., by selecting a button 406 or 410 in FIG. 4), various data may be collected and analyzed. For example, data collection module 16 may collect data relating to the user's choice and facilitate use of this data by other components such as monetization module 18. Thus, when the user indicates in the future that she wishes to consume content of a service provider, the collected data may be used to determine (304) appropriate price points.

Another example user interface 500 is shown in FIG. 5. The user may be presented with a matrix of price points for purchasing “gold coins” on seven different buttons 502. The first two price points (30 GC for $2, 90 GC for $5.99) may be without discount, e.g., due to a high transaction cost relative to revenue generated. But, the remaining price points may be increasingly discounted to account for a higher bulk of gold coins being sold. Additionally, the number of price points presented (seven) and the layout of those price points into a matrix may be based in part on aesthetic preferences 60 of users.

Although specific embodiments have been illustrated and described herein, it is noted that a wide variety of alternate and/or equivalent implementations may be substituted for the specific embodiment shown and described without departing from the scope of the present disclosure. The present disclosure covers all methods, apparatus, and articles of manufacture fairly falling within the scope of the appended claims either literally or under the doctrine of equivalents. This application is intended to cover any adaptations or variations of the embodiment disclosed herein. Therefore, it is manifested and intended that the present disclosure be limited only by the claims and the equivalents thereof.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. A computer-implemented method, comprising:
determining, by a computer system of a service provider, a geographic location of a user consuming or interested in consuming an online content hosted by the service provider;
determining, by the computer system, at least one price point at which to offer to the user rights to consume the online content or virtual goods associated with the online content, that is tailored for the geographic location to increase likelihood of acceptance of the offer by the user; and
causing to be presented to the user, at another computer system of the user, by the computer system, the at least one price point.

2. The computer-implemented method of claim 1, wherein determining the at least one price point further comprises determining the at least one price point based on one or more of the user's history consuming online content hosted by the service provider and the user's history of purchasing rights to consume online content or virtual goods associated with online content.

3. The computer-implemented method of claim 1, wherein online content hosted by the service provider has a plurality of types, and determining the at least one price point further comprises determining the at least one price point based on a type of the online content the user is consuming or is interested in consuming.

4. The computer-implemented method of claim 3, wherein determining the at least one price point further comprises determining the at least one price point based on spending history of other users of the type of online content the user is consuming or is interested in consuming.

5. The computer-implemented method of claim 4, wherein the type of the online content includes one or more of a genre of the online content, a creator of the online content, or a contributor to the online content.

6. The computer-implemented method of claim 1, wherein online content hosted by the service provider includes a plurality of network computer games, and determining the at least one price point further comprises determining the at least one price point based on which network computer game of the plurality of network computer games is being played by the user.

7. The computer-implemented method of claim 1, wherein determining the at least one price point further comprises determining the at least one price point based on a currency used at the geographic location.

8. The computer-implemented method of claim 1, wherein determining the at least one price point further comprises determining the at least one price point based on an aesthetic preference of users in a region containing the geographic location, the aesthetic preference being determined heuristically from the users in the region.

9. The computer-implemented method of claim 1, wherein determining the at least one price point further comprises determining the at least one price point based on one or more of an economy of the geographic location or income per capita of the geographic location.

10. The computer-implemented method of claim 1, wherein determining the at least one price point further comprises determining the at least one price point based on spending history of other users that are demographically similar to the user.

11. The computer-implemented method of claim 1, wherein determining the at least one price point further comprises determining the at least one price point based on spending history of other users who are “friends” of the user in a social network or “buddies” of the user in a buddy list.

12. The computer-implemented method of claim 1, wherein determining the at least one price point further comprises determining the at least one price point based on a payment method likely to be available to users at or near the geographic location.

13. The computer-implemented method of claim 1, wherein the at least one price point is a first price point of a first payment method, the method further comprising:
determining, by the computer system, a second price point of a second payment method at which to offer to the user rights to consume the online content or virtual goods associated with the online content; and
causing to be presented to the user, at the another computer system of the user, by the computer system, the second price point.

14. The computer-implemented method of claim 13, wherein the first payment method is one of payment with cash or payment with mobile points, and the second payment method is another of payment with cash or payment with mobile points.

15. The computer-implemented method of claim 1, wherein determining the at least one price point further comprises determining the at least one price point based on a value expected to be received by a content provider.

16. The computer-implemented method of claim 1, further comprising determining at least one amount of virtual goods associated with the online content to offer to the user at the at least one price point.

17. The computer-implemented method of claim 16, further comprising determining a discount price point at which to offer the at least one amount of virtual goods to the user where it is determined that the user is unwilling to accept the at least one amount of virtual goods at the at least one price point.

18. The computer-implemented method of claim 1, wherein the virtual goods are virtual currency.

19. The computer-implemented method of claim 1, wherein:
the at least one price point includes a plurality of price points based on the geographic location;
the user is presented with a number of price points of the plurality of price points from which to select; and
the number of price points presented to the user is determined heuristically from one or more of past activity of the user or past activity of a plurality of users in a region containing the geographic location.

20. A non-transitory computer-readable medium having computer-readable code embodied therein, the computer-readable code comprising instructions configured to enable an apparatus, in response to execution of the instructions, to perform a number of operations, including:
determining a geographic location of a user consuming or interested in consuming an online content hosted by the service provider;
determining at least one price point at which to offer to the user rights to consume the online content or virtual goods associated with the online content, that is tailored for the geographic location to increase likelihood of acceptance of the offer by the user;
determining at least one amount of virtual goods associated with the online content to offer to the user at the at least one price point; and
causing to be presented to the user, at a computer system of the user, the at least one price point for the amount of virtual goods.

21. The non-transitory computer-readable medium of claim 20, wherein the at least one price point includes a first price point of a first payment method, and the operations further include:
determining a second price point of a second payment method at which to offer to the user rights to consume the online content or virtual goods associated with the online content; and
causing to be presented to the user, at the computer system of the user, the second price point for the amount of virtual goods.

22. The non-transitory computer-readable medium of claim 20, wherein:
the at least one price point includes a plurality of price points;
the operations further include presenting the user with a number of price points of the plurality of price points from which to select; and
determining the number of price points presented to the user heuristically from one or more of past activity of the user or past activity of users in a region containing the geographic location.

23. A system, comprising:
one or more processors;
a content module configured to be operated by a processor of the one or more processors to facilitate, by a user at a computer system of the user, consumption of a content provided by a service provider;
a data collection module configured to be operated by a processor of the one or more processors to collect data relating to past consumption of content of the service provider by a plurality of users, including the user, over a period of time; and
a monetization module configured to be operated by a processor of the one or more processors to:
determine a geographic location of a user consuming or interested in consuming an online content hosted by the service provider;
determine at least one price point at which to offer to the user rights to consume the online content or virtual goods associated with the online content, that is tailored for the geographic location to increase likelihood of acceptance of the offer by the user; and
cause to be presented to the user, at a computer system of the user, the at least one price point.

24. The system of claim 23, wherein the monetization module is further configured to determine the at least one price point based on a currency used at the geographic location.

25. The system of claim 23, wherein the monetization module is further configured to determine the at least one price point based on an aesthetic preference of users in a region containing the geographic location, the aesthetic preference being determined heuristically from the users in the region.
